(19) United States
(12) Patent Application Publication
(10) Pub. No.: US 2004/0249958 A1
(43) Pub. Date: Dec. 9, 2004

(54) Method and apparatus for secure internet communications

(76) Inventors: Hasan Timucin Ozdemir, Plainsboro, NJ (US); Kou Chu Lee, Princeton Junction, NJ (US); Amit Thukral, Woodbridge, NJ (US)

Correspondence Address: HARNESS, DICKEY & PIERCE, P.L.C., P.O. BOX 828, BLOOMFIELD HILLS, MI, 48303, US

(21) Appl. No.: 10/454,336

(22) Filed: Jun. 4, 2003

(51) Int. Cl. G06F 15/16

(52) U.S. Cl. 709/229; 713/201

(57) ABSTRACT

Network communication from a client computer accessing an application service computer through use of the Internet (where the application service computer is normally protected from general Internet access by a firewall) is enabled by validating each computer message instance between the client computer and the application service computer against a first message permissive in a message address confirmation computer and a second message permissive in a firewall-tunnel computer. The firewall-tunnel computer and the message address confirmation computer interface directly to the Internet via secure protocol. The approach enables bi-directional multi-protocol communications by using HTTP protocol communications to the Internet in a computer systems infrastructure without need for re-configuration of firewall or NAT devices installed between the Internet and a network otherwise protected by a firewall or NAT device.

### FIELD OF THE INVENTION

The present invention relates to network communications between a client computer and an application service computer through use of the Internet where the application service computer is usually protected from general Internet access by a security device such as a firewall.

### BACKGROUND OF THE INVENTION

Network communication has become increasingly complex insofar as various network security devices such as firewalls and NATs (Network Address Translators) have been used by an ever-enlarging group of computer systems interfacing to the Internet. One significant difficulty introduced by these security devices is that comprehensive access between server and client (frequently using Remote Procedure Call or “RPC” communications) is frustrated via Internet to otherwise legitimate users when machines “behind” the NAT and Firewall devices are rendered inaccessible by the security devices.

Applications requiring remote access (for example, without limitation, Instant Messaging, IP Telephony, and security camera troubleshooting) are subject to such connectivity difficulties. In this regard, application servers for these types of applications frequently implement Hyper Text Transfer Protocol (HTTP) interfaces for remote management. Unfortunately, when such application servers implement important company applications at locations remote from a central computer maintenance group, their maintenance interfaces are not accessible by maintenance personnel through the Internet because of their corresponding firewalls. Company personnel therefore frequently need to be physically transported to the location of an affected computer to implement corrective procedures when the management interface needs to be used (and when, ironically, a remote management interface could have been used except for blocking caused by the NAT/firewall). In this regard, of course, network security needs to be sustained even as corrective measures need to be implemented to the system; but the cost of this sustained security in time and money is substantial.

When connectivity between two domains (each behind a firewall) is needed, system administrators need to open certain ports on those firewalls so that the two domains can exchange messages between applications on the two domains. This unfortunately is not an acceptable solution for a majority of customers, because security features may be violated.

Even as connectivity through firewalls and NAT is highly desired for cost and security reasons, there is still a need to only access these security devices according to their particular protocol requirements so that security is sustained in such communications. What is needed is a way to securely access application servers through a firewall from the Internet such that the convenience and low cost of firewall-protected local area networks attached to these applications serves is realized even as secure comprehensive bi-directional communication across the Internet and around the firewall is enabled when needed. It is also highly desired that reconfiguration of a firewall will not be needed to enable such comprehensive bi-directional communication capability across the Internet. The present innovation solves this problem.

### SUMMARY OF THE INVENTION

The invention provides a method for network communication from a client computer accessing an application service computer through use of the Internet. The method validates each computer message instance in a communication between the client computer and the application service computer against a first message permissive in a message address confirmation computer and a second message permissive in a firewall-tunnel computer. The firewall-tunnel computer and the message address confirmation computer interface to the Internet.

Further areas of applicability of the present invention will become apparent from the detailed description provided hereinafter. It should be understood that the detailed description and specific examples, while indicating the preferred embodiment of the invention, are intended for purposes of illustration only and are not. intended to limit the scope of the invention.

### BRIEF DESCRIPTION OF THE DRAWINGS

The present invention will become more fully understood from the detailed description and the accompanying drawings, wherein:

FIG. 1 shows a computer network interfacing a message instance through the use of the Internet using a message address confirmation computer and a firewall-tunnel computer;

FIG. 2 shows a software architecture for message management according to the network of FIG. 1; and

FIG. 3 shows message exchange detail between two IP platforms using the network and architecture of FIGS. 1 and 2.

### DETAILED DESCRIPTION OF THE PREFERRED EMBODIMENTS

The following description of the preferred embodiment(s) is merely exemplary in nature and is in no way intended to limit the invention, its application, or uses.

In overview, a firewall-tunnel computer (running bridge software that recognizes a message address confirmation computer as valid Internet-interfaced user) interfaces to the Internet around (or by figuratively “tunneling through”) a protective firewall securing normal communications between a client computer and the application service computer. The message address confirmation computer interfaces to the Internet to only recognize specific clients and its firewall-tunnel computers as valid Internet-interfaced users. The client computers, firewall-tunnel computers, and the message address confirmation computer preferably belong to an internal corporate functional group having a high degree of trust between personnel in the group. An example of such a group is a computer-oriented service group designated herein as an Operations Administration and Maintenance (OA&M) group within an exemplary corporation.

Message permissive data is established in a database of the firewall-tunnel computer as well as in a database of the message address confirmation computer. Each instance of a computer message in a communication from a client computer to an application service computer is then passed through a validation process against the database of the message address confirmation computer, to a validation process against the database of the firewall tunnel computer of the application service computer, and thence to the application service computer. Each instance of a computer message in a communication from the application service computer to the client computer is passed through a validation process against the database of the application service computer, to a validation process against the database of the message address confirmation computer, to a validation process against the database of the firewall tunnel computer (if any) of the client computer, and thence to the client computer.

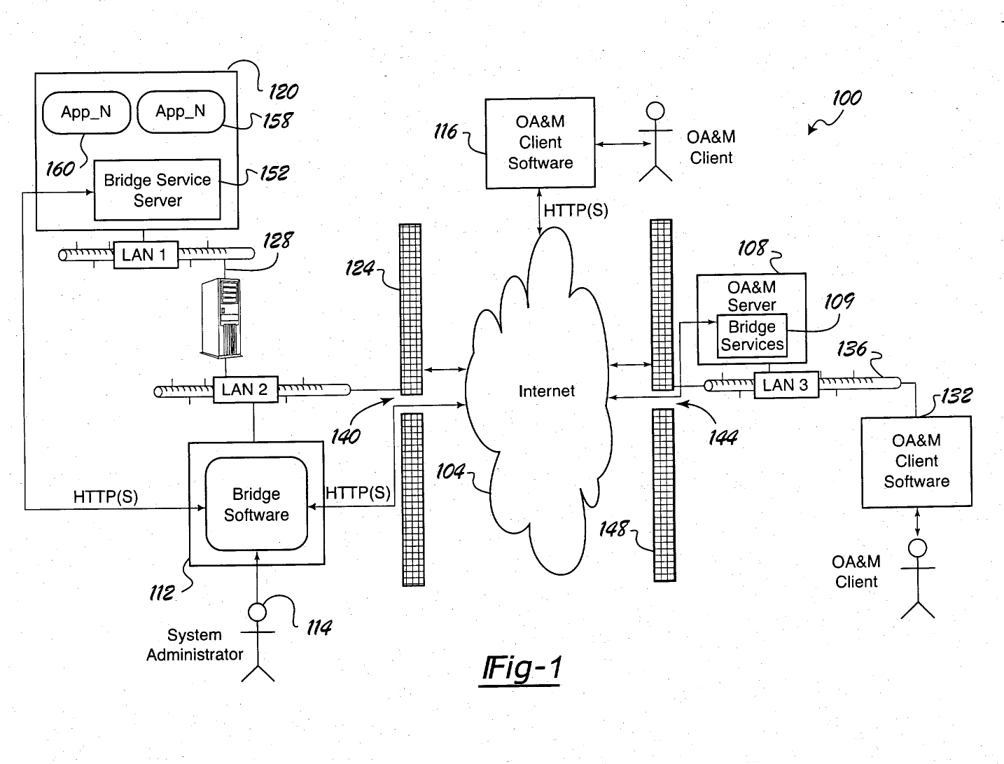

The OA&M message address confirmation database is essentially under the control of the system administrators of the firewall tunnel computers. Any of these system administrators logs into the OA&M center from their firewall tunnel computer and creates (in the database of the message address confirmation computer) a permissive for a bridge for messages between the message address confirmation computer in the OA&M center and the firewall tunnel computer on the local area network of the application server computer, firewall-tunnel computer, and system administrator. This provides an access path to the application server computer from the message address confirmation computer in the OA&M center. After the connectivity is established, OA&M client computers access the application server computer by using the “tunnel” created by the system administrator from the message address confirmation computer in the OA&M center to the application server computer via the firewall tunnel computer. The system administrator also creates a permissive in the firewall tunnel computer enabling messages from the message address confirmation computer in the OA&M center to proceed to the application server computer. Each message instance between the client computer and the application service computer is then subjected to validation from the permissive data of both computers (the firewall-tunnel computer and the message address confirmation computer in the OA&M center) executing the effective Internet-enabled bridge. Turning now to FIG. 1, a computer network 100 interfacing a message instance through the use of Internet 104, message address confirmation computer 108, and firewall-tunnel computer 112 is shown. Client computer 116 and an application service computer 120 exchange a message through Internet 104. Protective firewall 124 protects local area network (LAN 1 and LAN 2 as interconnected) 128 from general access to Internet 104. Client computer 132 interfaces to message address confirmation computer 108 and to Internet 104 via LAN 136 (in one embodiment, LAN 136 is corporate intranet 136). Firewall 148 protects second client computer 132, message address confirmation computer 108, and LAN 136 from general access to Internet 104. Application service computer 120 executes application 160 and application 158. Application service computer 120 also executes a bridge service server 152. Bridge service server 152 directs message instances to firewall-tunnel computer 112 in response to message instances received from a client (such as client computer 116) via firewall-tunnel computer 112 (and message address confirmation computer 108).

Message address confirmation computer 108 preferably interfaces to Internet 104 via HTTPS (HTTP secure protocol) to only recognize specific clients (such as client computer 116) and its firewall-tunnel computers (such as firewall-tunnel computer 112) as valid Internet 104 users. These HTTP secure protocol “tunnel” accesses to Internet 104 are symbolically illustrated with connection tunnel 140 in firewall 124 and also with connection tunnel 144 in firewall 148. In linkage, connection tunnel 140 in firewall 124 and connection tunnel 144 in firewall 148 physically bypass their corresponding firewalls and datalogically buttress security with message-by-message address permissive validation methodology as described in this specification. In lieu of HTTP secure protocol (HTTPS), an alternative embodiment uses an encryption approach providing the appropriate security for the particular needs of the network owner. In one embodiment, one port of a firewall enabling configurable individual ports is opened for HTTP protocol interface and message address confirmation computer 108 and/or firewall-tunnel computer 112 provide the sole connection to the HTTP protocol configured port.

The system administrator 114 of firewall-tunnel computer 112 creates the “tunnel” between the message address confirmation computer 108 and application service computer 120 after logging into message address confirmation computer 108 so that the necessary authorization and privacy is satisfied. The system administrator has essentially full control over the connection to message address confirmation computer 108 and terminates the connection either physically or datalogically at his or her discretion. Since the connection does not require the opening of any port on firewall 124, company network 128 is protected from outside attackers. Once tunnel 140 is established between application service computer 120 and message address confirmation computer 108, the clients of message address confirmation computer 108 (OA&M clients such as client 116 or client computer 132) access application service computer 120 via message address confirmation computer 108 and firewall tunnel 140 (as enabled by firewall-tunnel computer 1 12).

The overall system design is based a queue mechanism running on HTTP. The queue paradigm provides simple primitives for createOueueQ(), removeQueueo, sendSynch(), and send Asyncho messages. “Pull with time out” and “maximum number of messages to retrieve” are used to push message instances back to the client. A primitive getMessages command in the preferred attribute form of (Sessioninbox,MaxNumberOfMsgs,TimeOut) is used to retrieve messages addressed to application queues. Returned messages contain one or multiple messages (to some maximum limit) and are dispatched to appropriate queues (and applications waiting on those queues to process requests).

Each message contains an envelope carrying a message body and a message header. Bridge software executing in firewall-tunnel computer 112 runs in one embodiment as a standalone program. In an alternative embodiment, the bridge software runs as assigned applet within a browser. In one embodiment, an applet version of the bridge software executes in InternetExplorer and works with Microsoft JVM or Sun Java Plug-in.

The permissive structure in the database of message address confirmation computer 108 is, at a minimum, comprised of a set of data records with each data record specifying a firewall-tunnel computer 112 and client computer 116 (or client computer 132) address couplet as a permissive. In an alternative embodiment, firewall-tunnel computer 112 and client computer 116 (or client computer 132) address permissive indicators are enhanced to a triplet with an application service computer 120 address permissive. In yet another embodiment, the application service computer 120 address permissive is further enhanced with a specific application 160 or 158 identifying permissive.

The permissive structure in the database of firewall-tunnel computer 112 is, at a minimum, comprised. of a set of data records with each data record specifying an application service computer 120 address permissive. In an alternative embodiment, application service computer 120 permissive identifiers are enhanced with client computer 116 (or 132) address permissive identifiers. In yet another embodiment, the application service computer 120 address permissive is further enhanced with a specific application 160 or 158 identifying permissive.

Bridge service server 152 on application service computer 120 optionally executes password protection, address identifier permissive validation, or the like as the particular application (158, 160) may require.

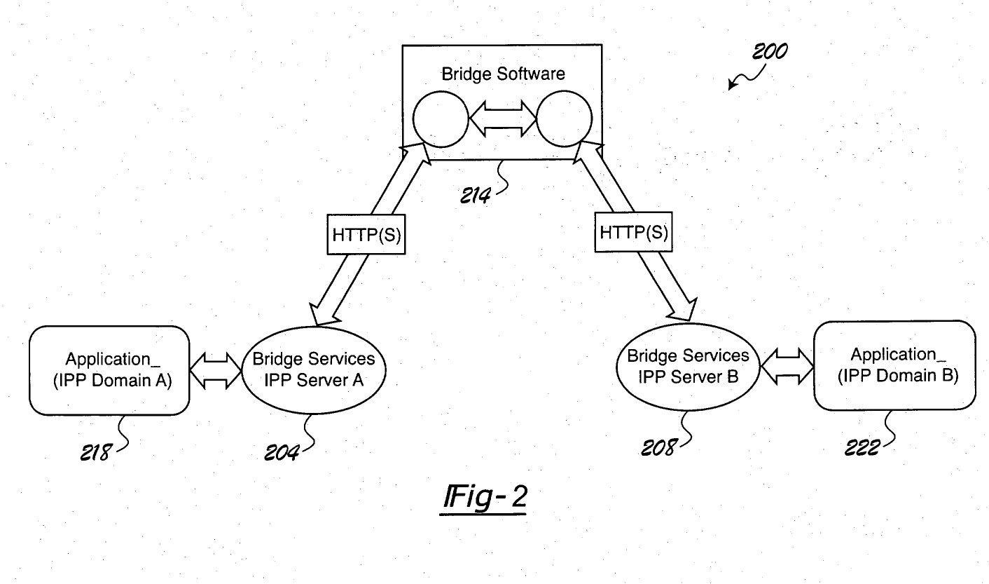

Turning now to FIG. 2, software bridge architecture 200 for message management is presented according to the network of FIG. 1. Bridge services 204, 208 on either side of the tunnels (140, 144) take care of the marshaling and un-marshaling of Information Processing Platform (IPP) messages before transmitting them through their appropriate “tunnel” to Internet 104. Besides marshalling and un-marshalling, bridge services 204 and 208 provide capabilities to send messages synchronously and asynchronously and to receive messages. Bridge software 214 includes the software of message address confirmation. HTTP(S) communications between bridge services 204 and bridge software 214 and between bridge services 222 and bridge software 214 are secured by use of SSL (Secure Socket Layer) or TLS (Transport Layer Security) in HTTP(S).

In further detail, bridge services 204 and 208 are implemented preferably by using Java Servlet technology. bridge services 204 and 208 allow bridge software 214 (for instance, as executed in firewall-tunnel computer 112) to login, create remote queues, and send and receive messages. Each login creates a session in the appropriate service, and queues are then associated with that session for message routing. Bridge services 204 and 208 and bridge software 214 contain mapping between the bridged queues and IPP queues for forwarding messages between domains. The messages are queued in the bridge service (for example, bridge server 204 of Domain A) to be transported to another bridge service (for example, bridge server 208 of Domain B).

Bridge software 214 has two layers in one embodiment. A first layer is a transport layer providing HTTP connections with each bridge service (204 and/or 208) to exchange messages. A second layer is a message processing layer which routes message instances to each bridge service 204 or 208. The transport layer provides the interfaces as follows in one embodiment:

Send (send asynchronously).

SendAndWait (send synchronously),

Receive (receive messages queued up) and

ReceiveAndReply (receive messages for callback function).

The above interfacing command calls provide flexibility for the message processing layer and/or for interactions between applications accessible via bridge services 204 and/or 208.

Bridge software 214 (executing, for example in tunnel-computer 112) initiates the HTTP connection to bridge service 204 (for example, bridge service 109 running in message address confirmation server 108) and bridge service 208 (for example, bridge services server 152 running in application server 120). The initialization phase of the connection includes the authentication of the bridge software connection instance by message address confirmation server 108. The execution of bridge software 214 is controlled by a user (such as a system administrator) or by an application program to create a tunnel between message address confirmation server 108 and an application server dynamically. Bridge software 214 defines a send message buffer and a receive message buffer pair for each HTTP connection to bridge services 204 and/or 208. The transport layer of bridge software 214 retrieves messages from bridge services 204 and/or 208. The transport layer of bridge software 214 also sends messages to bridge services 204 and/or 208. The transport layer of bridge software 214 also sends and receives multiple messages in a single interaction with bridge services 204 and/or 208 when needed. The transport layer of bridge software 214 creates multiple connections to bridge services 204 and/or 208 to reduce message latency and to increase message throughput while preserving the order of messages. The message processing layer creates a send message buffer and a receive message buffer for each connection to bridge services 204 and/or 208. The message processing layer of bridge software 214 moves messages from the send message buffer associated with bridge service 204 to the receive message buffer associated with bridge service 208. It also moves messages from the send message buffer associated with bridge service 208 to the receive message buffer associated with the bridge service 204. Each of the message movements is performed after executing appropriate permission checking for transfer of the message. The exchanged messages usually are structured according to different protocols for respectively different applications.

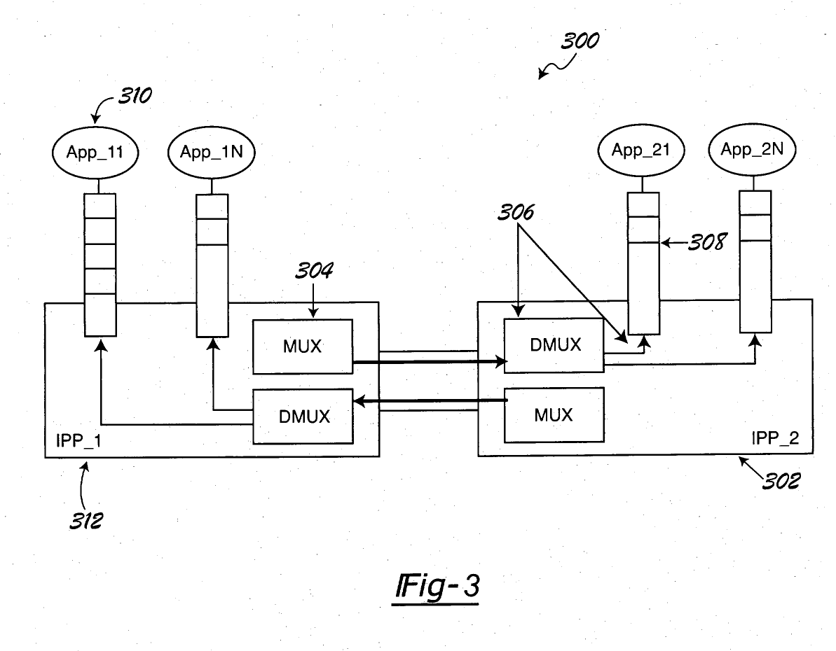

Bridge services 204 and/or 208 create(s) a send message buffer for each connection enabled by bridge software 214. Bridge services 204 and/or 208 buffer(s) the messages destined to a particular bridge software instance in the associated send message buffer. The transport layer of bridge software 214 retrieves the message from this associated send buffer. Bridge services 204 and/or 208 handle(s) concurrent message retrieval requests initiated by bridge software programs as needed. Bridge services 204 and/or 208 forward(s) the messages send by bridge software programs to the proper local or remote application queues (see interactive message detail 300 of FIG. 3).

In one embodiment, bridge service software (server software 204 or 208) executes on a host computer on which an application server is running (in which case the application service. computer and the firewall-tunnel computer may be effectively structured as logically-separate computers sharing a CPU and possibly a disk). Preferably, however, firewall-tunnel software is put on one host accessing a separate application server such as server 120.

System Administrator 114 accesses bridge software 214 on the OA&M center message address confirmation computer 108 via Internet 104. In a preferred embodiment, OA&M center message address confirmation computer 108 authenticates System Administrator 114 by username and password.

The benefits from the networking methodology described herein are manifold. An application server can be behind the NAT/Firewall and not require any configuration from the network administrator to achieve connectivity to the application server. A “hole” is not “punched” through a NAT/Firewall specifically since all connections are opened from inside the NAT/firewall to Internet 104; messaging is therefore not dependent on NAT features (such as symmetric or bidirectional features). System Administrator 114 can terminate the bridge at any time. Message traffic can be secured with SLL or TLS. And clients can be either on a corporate intranet 136 or on Internet 104. A bridge services server 152 can run anywhere on a customer network as long as it can access to the application server (such as server 120). For example, it can run on the System Administrator's machine, co-located with the application server, on another machine that is not accessible from Internet 104, or on another machine that is accessible from Internet 104. (When bridge services are executed in the System Administrator's machine, they are preferably initiated exclusively for providing a bridge between the message address confirmation computer 108 and the application server. When the bridge services server is run on a machine that is accessible from Internet 104, the System Administrator 114 configures the corresponding firewall to be able to access the bridge services server for firewall-tunnel computer 112 from Internet 104. Such a feature enables System Administrator 114 to establish a tunnel from anywhere on Internet 104 through use of a browser.)

Another benefit of the innovation is that secured protocol communications can be enabled in an ongoing way in a computer systems infrastructure without needing re-configuration of Firewall/NAT devices installed between the Internet and an application service computer network. In this regard, when firewall-tunnel computer 112 interfaces to Internet 104 through a firewall port connection configured to enable outbound HTTP protocol communication to proceed by firewall 124, the reconfiguration of the particular firewall port for inbound communication is not needed for enabling bidirectional multi-protocol messaging between applications (such as messaging between a client computer and an application service).

In one embodiment, bridge software is under control of System Administrator 114 via a Graphical User Interface within a web browser. In another embodiment, where a computer on which a desired application program is configured for secure access to the Internet via HTTP/HTTPS bridge software as described herein, access is under the control of the application program. In either case, re-configuration is not needed of Firewall/NAT devices on the network on which the application server computer is running.

In one embodiment, application service computer 120 is not connected to LAN 128 and therefore has no access to Internet 104 except via a point-to-point connection with firewall tunnel computer 112. In yet another embodiment, application service computer 120 is not connected to LAN 128, accesses Internet 104 directly using bidirectional messaging over HTTP/HTTP(S), and executes the bridge software to provide permissive-secured bi-directional messaging over HTTP/HTTP(S) as described herein.

In one embodiment, the described methodology enables multiple corporations to subscribe to a service for enabling network communications from a client computer accessing an application service computer through use of the Internet where the application service computer is protected from general Internet access by a security device such as a firewall and a message address confirmation computer is available as a service for enabling maintenance tunnels. In this case, the owner of the message address confirmation computer enters into an agreement with owners of the application service computers and corresponding firewall-tunnel computers. In the agreement, there is, for instance, a stipulation that the owner of the message address confirmation computer will not edit the message permissive indicators of a subscribing owner of an application, so that the security interests of the application owners are protected. Turning now to FIG. 3, interactive message detail 300 between a first IP Platform (IPP) 312 and a second IP Platform (IPP) 302 shows message oriented middleware supporting multi-protocol communication between applications to further extend the applicability of the firewall-tunnel-enabled network linkages. In this regard, IP Plafforms 312 and 302 are each similar to application service computer 120 and exchange messages in a communication according to the methodology and topography described for computer network 100. Individual messages are multiplexed in multiplexer 304 in IPP 312 and de-multiplexed and dispatched to an application queue 308 in IPP 302. Each application (for example App_11, App_1N, App_21, and App_2N as shown in detail 300) has its own application queue (as shown in example by queue 308 as specifically associated with App_21 in IP Platform 302) for receiving messages from the de-multiplexer of the IPP executing the application. Application 310 defines its particular messaging format (protocol) prior to multiplexing of its message in multiplexer 304. Such dedicated receiving queues support synchronous and asynchronous message delivery in application service computers of network 100 and provide comprehensive and flexible communication middleware for application developers. The dedicated queues also provide a basis for flexible message exchange between applications running in the same IP Platform (“threads”) and/or applications running in different IP Platforms (“processes”).The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for network communication from a client computer accessing an application service computer through use of the Internet, comprising:
validating each computer message instance between said client computer and said application service computer against a first message permissive in a message address confirmation computer and a second message permissive in a firewall-tunnel computer wherein said firewall-tunnel computer interfaces said application service computer to said Internet and said message address confirmation computer interfaces to said Internet.

2. The method of claim 1 wherein said first message permissive comprises an identifier for said firewall-tunnel computer in relation to an identifier for said client computer.

3. The method of claim 2 wherein said first message permissive further comprises an identifier for said application service computer in relation to said identifier for said firewall-tunnel computer and said identifier for said client computer.

4. The method of claim 3 wherein said identifier is a logical identifier for said application service computer.

5. The method of claim 3 wherein said identifier is a logical identifier for an application of said application service computer.

6. The method of claim 1 wherein said second message permissive comprises an identifier for said application service computer.

7. The method of claim 6 wherein said second message permissive further comprises an identifier for said client computer.

8. The method of claim 1 wherein said first message permissive is defined in said message address confirmation computer by said firewall-tunnel computer.

9. The method of claim 1 further comprising validating a password of said client computer by said application service computer.

10. The method of claim 1 further comprising validating a password of said firewall-tunnel computer by said message address confirmation computer.

11. The method of claim 1 wherein said message address confirmation computer is owned by a first owner and said application service computer and said firewall-tunnel computer are owned by a second owner, said method further comprising said first and second owners agreeing that said first owner will not edit said first message permissive.

12. The method of claim 1 wherein said firewall-tunnel computer interfaces to said Internet through a firewall port connection configured to enable an outbound HTTP protocol communication to proceed by said firewall, said firewall essentially permanently configured to block any inbound communication which is not reciprocal to said outbound communication so that reconfiguration of said firewall port is not needed for enabling bi-directional messaging through said firewall.

13. A method for network communication from a client computer accessing an application service computer through use of the Internet, comprising:
providing a firewall-tunnel computer in data communication to said application service computer and to said Internet;
providing a message address confirmation computer in data communication to said firewall-tunnel computer through said Internet and in data communication to said client through said Internet; and
validating each computer message instance of said communication between said client computer and said application service computer against a first permissive database in said message address confirmation computer and a second permissive database in said firewall-tunnel computer.

14. The method of claim 13 wherein said first message permissive database comprises a data record having an identifier for said firewall-tunnel computer in relation to an identifier for said client computer wherein said data record addresses are defined in said first message permissive database from said firewall-tunnel computer.

15. The method of claim 14 wherein said data record further comprises an identifier for said application service computer.

16. The method of claim 13 wherein said second message permissive database comprises a data record having an identifier for said application service computer.

17. The method of claim 16 wherein said second message permissive database further has an identifier for said client computer.

18. An apparatus for network communication from a client computer accessing an application service computer through use of the Internet, comprising:
a firewall-tunnel computer in data communication to said application service computer and to said Internet, said firewall-tunnel computer programmed to validate each computer message instance of said communication between said client computer and said application service computer; and
a message address confirmation computer in data communication to said firewall-tunnel computer through said Internet and in data communication to said client through said Internet, said message address confirmation computer programmed to validate each computer message instance of said communication between said client computer and said application service computer.

19. The apparatus of claim 18 wherein said message address confirmation computer has a permissive database having an identifier for said firewall-tunnel computer in relation to an identifier for said client computer.

20. The apparatus of claim 19 wherein said message address confirmation computer and said firewall-tunnel computer are programmed to enable said firewall-tunnel computer to modify said permissive database in said message address confirmation computer.

21. An apparatus for network communication from a client computer accessing an application service computer through use of the Internet, comprising:
means for validating each computer message instance between said client computer, and said application service computer against a first message permissive in a message address confirmation computer and a second message permissive in a firewall-tunnel computer wherein said firewall-tunnel computer interfaces to said Internet and said message address confirmation computer interfaces to said Internet.

22. The apparatus of claim 21 further comprising means for defining said first message permissive by said firewall-tunnel computer.

23. The method of claim 1 wherein said firewall-tunnel computer. executes a bridge computer program and wherein an application program in said application service computer controls said bridge computer program such that an HTTP message transport mechanism is created with said message address confirmation computer.

24. The method of claim 12 wherein said firewall-tunnel computer executes a bridge computer program, said bridge computer program creates a bridge software instance by initiating an HTTP connection to said message address confirmation server and by initiating an HTTP connection to said application service computer, and said message address confirmation server authenticates said bridge software instance.

25. The method of claim 12 wherein said firewall-tunnel computer executes a bridge computer program, said bridge computer program creates a bridge software instance by initiating an HTTP connection to said message address confirmation server and by initiating an HTTP connection to said application service computer, said bridge computer program defines a message buffer pair set such that a send message buffer and a receive message buffer pair is defined for each said HTTP connection, and said message buffer pair set transfers messages bi-directionally between a bridge services computer program executing in said message address confirmation computer and a bridge services computer program executing in said application service computer.

26. The method of claim 12 wherein said firewall-tunnel computer executes a bridge computer program having a transport layer and a message processing layer, said transport layer initiates a first HTTP connection to said message address confirmation server and a second HTTP connection to said application service computer, said message processing layer defines a message buffer pair set such that a send message buffer and a receive message buffer pair is defined for each said HTTP connection, said transport layer retrieves a first message in a communication from said message address confirmation server via said first connection, said message processing layer executes permission rules on said first message, said message processing layer moves said first said message from the receive message buffer of said first connection to the send message buffer of said second connection, said transport layer sends said first message to said application service computer via said second connection, said transport layer retrieves a second message in a communication from said application service computer via said second connection, said message processing layer executes permission rules on said second message, said message processing layer moves said second message from the receive message buffer of said second connection to the send message buffer of said first connection, and said transport layer sends said first message to said message address confirmation server via said first connection.

27. The method of claim 12 wherein messages of said messaging are structured according to differentiated protocols respective to differentiated applications.

28. The method of claim 12 wherein said firewall-tunnel computer executes a bridge computer program having a transport layer and a message processing layer, said transport layer multiplexing the sending of a plurality of messages to said message address computer and to said application service computer.

29. The method of claim 12 wherein said firewall-tunnel computer executes a bridge computer program having a transport layer and a message processing layer, said transport layer receive multiplexing a plurality of messages from a bridge service program in said message address computer and from a bridge service program in said application service computer.

30. The method of claim 12 wherein said firewall-tunnel computer executes a bridge computer program having a transport layer and a message processing layer, said transport layer creating a sufficient plurality of HTTP connections with said message address computer and a sufficient plurality of HTTP connections with said application service computer such that overall message latency is sustained below a predefined latency value and overall message throughput is sustained below a predefined throughput value.

31. The method of claim 12 wherein a plurality of firewall-tunnel computers are in communication with said message address confirmation server and wherein each firewall-tunnel computer executes a bridge computer program enabling said messaging.

32. The method of claim 1 wherein a plurality of firewall-tunnel computers are in communication with said message address confirmation server, each firewall-tunnel computer executes a bridge computer program enabling said messaging, and said message address confirmation server executes a bridge service program in communication with the bridge computer programs in said plurality of firewall-tunnel computers.

33. The apparatus of claim 21 wherein said means for validating each computer message instance further comprises a bridge computer program in each said firewall-tunnel computer and a bridge service program in said message address confirmation computer, wherein said bridge service program defines a send message buffer for each said bridge computer program, and said bridge service program buffers each message instance communicated to each said bridge computer program in its respective said send message buffer.

34. The apparatus of claim 33 wherein said bridge service program buffers a plurality of messages sent from one said bridge computer program.

35. The apparatus of claim 21 wherein said means for validating each computer message instance further comprises a bridge computer program in each said firewall-tunnel computer and a bridge service program in said message address confirmation computer, wherein said bridge service program is capable of accepting a plurality of messages sent by each bridge computer program, said bridge service program defines a send message buffer for each said bridge computer program, said bridge service program buffers each message instance communicated to each said bridge computer program in its respective said send message buffer, and said bridge service program forwards each message to a commensurate application message queue.
